(19) United States
(12) Patent Application Publication
(10) Pub. No.: US 2007/0247505 A1
(43) Pub. Date: Oct. 25, 2007

(54) Apparatus and method for printing corrugated cardboard sheets

(76) Inventors: Hideyuki Isowa, Kasugai-shi (JP); Kazuhiro Hatasa, Kasugai-shi (JP); Shunji Kato, Kasugai-shi (JP)

Correspondence Address: BRINKS HOFER GILSON & LIONE, P.O. BOX 10395, CHICAGO, IL, 60610, US

(21) Appl. No.: 11/409,551

(22) Filed: Apr. 20, 2006

(51) Int. Cl. B41J 2/01

(52) U.S. Cl. 347/101

(57) ABSTRACT

A printer using ink jet printing technology to print one or more colors on a sheet for use in a box is described. The printer has a feeder, a transport mechanism for moving the sheet the print head, and a stacker to receive the printed sheet. Differential air pressure is applied by a suction box disposed in proximity to a conveyer belt for transporting the sheet. The suction box may sized so that the sheet may be oriented with a long dimension in the direction of feeding. Where multiple print heads are used, the print heads overlap in the direction transverse to the motion of the sheet so that an image larger than a print head may be produced. Two printing mechanisms disposed opposite each other may be used to print two sides of a sheet.

### TECHNICAL FIELD

This application relates to an apparatus and method of printing on corrugated cardboard sheets, and in particular to the printing of corrugated cardboard sheets for corrugated boxes, one-by-one.

### BACKGROUND

Where corrugated cardboard sheets for corrugated boxes are printed one-by-one, an area of the corrugated cardboard sheet to be printed is a portion of the surface of the corrugated cardboard sheet corresponding to four face sides of the box to be formed from the sheet. On the planar cardboard sheet to be printed, the four face sides have an overall rectangular shape.

As shown in an elevation view in FIG. 1, a printer system 1 for a corrugated cardboard sheet 5, includes a feeder 10 having a kicker 11 for feeding the sheets 5, one or more printer stages 20, a creaser or slitter 30, a slotter 40, and a stacker (not shown), disposed in sequence along the direction of travel of the sheet 5 to be printed. The direction of travel of the cardboard sheet from the feeder 10 through the remainder of the printer system 1 is from right to left as shown by the broad arrow. Each of the printer stages includes a pair of rollers, 22a and 22b, where one of the rollers 22b has a printing die 23 (shown in FIG. 2) on the peripheral surface thereof. The second of the rollers 22a acts as a pressure roller in the printing process. The corrugated cardboard sheet 5, shown in plan view, is passed between the rollers 22a and 22b of each of the stages of the printer, where the rollers 22a and 22b are sized and dimensioned so that a predetermined nip pressure causes the corrugated cardboard sheet 5 sheet to be propelled in the direction of feed. At the time of passage between the rollers 22a and 22b, one surface of the corrugated cardboard sheet 5 is printed by contacting the corrugated cardboard sheet 5 with the printing die 23. Thus the pair of rollers 22a and 22b serve both to transport the sheet from stage-to-stage of the printer 1 and to print the image on the sheet with the printing die 23 affixed to the periphery of the roller 22b.

Each of the colors which may be required in the printing process is applied by a separate printer stage 20, the printer stages being disposed along the direction of feed of the sheet 5. Examples of printing on the sheet 5 are shown in FIG. 1, each example representing the state of the sheet 5 after completion of the printing process represented by the stage 20 of the printer 1 disposed adjacent thereto.

FIG. 2a shows the relationship of a corrugated cardboard sheet 5 (or “sheet”) to the printing cylinder of a stage 20 of the printer 1. A printing area 6, shown as a lined region of the sheet 5, represents that area of the surface of the sheet 5 where printing may be performed. The width of the area to be printed corresponds to the width W of the printing die 23. The longer dimension X of the sheet 5 may be termed the “longitudinal” dimension, and the shorter dimension Y of the sheet 5 may be termed the “transverse” dimension. In the example of FIG. 1, the sheet is being fed through the printer 1 in the transverse direction; that is, the transverse dimension of the sheet is oriented in the direction of travel of the sheet 5 through the printer 1. An edge of the sheet 5 is also shown where the corrugations may be seen to have an approximately sinusoidal shape having an upper and lower surface adhered thereto. As shown, the direction of corrugation is along the transverse direction of the sheet 5, such that the sinusoidal form extends in the longitudinal direction.

The length of the print area 6 determines the circumferential length of the print die 23 on the periphery of the printing cylinder 22b. The linear length along the direction of travel of the sheet 5 which can be printed by the printing die 23 depends on the diameter D of the cylinder 22b and the angular extent 0 of the periphery occupied by the printing die 23. For a fixed angular extent θ, the diameter D of the print cylinder 22b depends linearly on the longitudinal dimension X of the sheet 5. As the size of the sheet 5 increases, the diameter of the printing cylinder 22b increases accordingly, and the overall dimensions of the printer 1 may be come quite large, and is determined by the longitudinal dimension of the largest sheet that the printer is intended to accommodate.

The corrugated cardboard sheet 5 may also be fed so that the longitudinal dimension X is perpendicular to the direction of feed, as shown in FIG. 1. This arrangement results in increasing the width of the printer 1 in accordance with the maximum longitudinal dimension X of sheets 5 to be accommodated by the printer 1. FIG. 1 shows a situation where an area on the corrugated cardboard sheet 5, corresponding to a faces of the completed box 50, are separately printed with a different color, and the color is represented by a differing symbol (circle, triangle, square and star). Of course each of the faces may be printed with all of the colors and the example is merely for clarity. However, particularly in the situation which obtains when there is a face on which not all of the colors are printed on each box face portion of the corrugated cardboard sheet 5, the orientation of the corrugated cardboard sheet 5 with respect to the direction of feed may be altered, resulting in a lack of registration of the images or colors.

### BRIEF SUMMARY

A printer is described, including a conveyer belt having a plurality of apertures extending between a first side and a second side thereof and a suction unit for sucking a corrugated sheet to be printed toward the first side of the conveyor belt. The conveyer belt is an endless belt, engaged with pulleys separated from each other along the direction of motion, and the suction unit includes a suction box communicating with the apertures of the conveyer belt through a plurality of perforated holes. A plurality of ink jet is nozzles disposed transverse to the direction of motion of the conveyer belt, and the ink jet nozzles spaced apart from the surface of the corrugated sheet.

In another aspect, a printer includes a means for feeding a sheet to be printed and a plurality of ink jet nozzles disposed transverse to the direction in which the sheets are fed. The ink jet nozzles are spaced apart from the surface of the sheets to be printed at a predetermined distance, and dots are formed on the surface of the sheet by ink droplets jetted out from the plurality of ink jet nozzles toward the surface of the sheet. The means for feeding a sheet includes a pair of pulleys separated from each other in the feeding direction, and an endless conveyor belt including a plurality of perforated holes on the surface thereof, the endless belt movable by the pair of pulleys. A suction unit sucks the sheet toward the surface of the conveyor belt through the plurality of perforated holes. The suction unit includes a suction box vented through the plurality of perforated holes, a means for sucking air from the suction box, and a pair of baffle plates in the suction box for adjusting a suction area in the suction box. The width of the suction area is approximately equal to a width of a printing area on the sheet, where the width is measured substantially perpendicular to the feeding direction.

In yet another aspect, a printer includes a conveyer belt having a porosity to air; a suction box, disposed opposite a first surface of the conveyer belt; and a ink jet print head disposed facing a second surface of the conveyer belt. The suction box has a pair of baffles spacable apart so that a suction area is formed beneath approximately the width of a print area.

In a further aspect, a printer includes a first printing mechanism, and a second printing mechanism, where the first and second printing mechanisms are sequentially disposed along a path of a sheet to be printed. Each of the first and the second printing mechanisms includes a conveyer belt having a porosity to air; a suction box, disposed opposite a first surface of the conveyer belt; and a print head disposed facing a second surface of the conveyer belt.

The print head of the first printing mechanism is disposed opposite a first side of the sheet to be printed, and the print head of the second printing mechanism is disposed opposite a second side of the sheet to be printed. 28. A dryer is disposed between the print head of the first printing mechanism and the second printing mechanism.

In a further aspect a printer includes a first conveyer belt and a second conveyer belt, sequentially disposed along a path of a sheet to be printed; a first suction box and a second suction box, disposed opposite a first surface of the first conveyer belt and a first surface of the second conveyer belt, respectively. An upper print head is disposed so as to eject ink in a downward direction towards an upper surface of the sheet to be printed; and, a lower print head disposed so as to eject ink in an upward direction towards a lower surface of the sheet to be printed. A dryer is disposed between one of the upper print head or the lower print head and the second conveyer belt.

In still another aspect, a printer includes a means for conveying a sheet to be printed, and a plurality of ink jet nozzles disposed transverse to a direction of motion of the sheet, the ink jet nozzles spaced apart from a surface of the sheet to be printed. A first plurality of ink jet nozzles is disposed opposing a second plurality of ink jet nozzles such that the sheet to be printed is conveyed therebetween by the means for conveying.

A method of printing on a surface of an individual sheet is described, the method including the steps of: providing a conveyer belt with a suction box disposed facing a first surface thereof; providing an ink jet print head disposed such that the ink jet nozzles are in a line perpendicular to the direction of motion of the conveyer belt; disposing the ink jet print head facing a second surface of the conveyer belt; sensing the position of a first edge of the sheet; and controlling the ink jet print head to deposit ink to form an image in accordance with image data received by a controller.

### BRIEF DESCRIPTION OF THE DRAWINGS

FIG. 1 shows an example of a prior art printing process using multiple print rollers;

FIG. 2 illustrates the relationship of the dimensions of a printing plate in prior art printing process of FIG. 1 to the area on a cardboard sheet to be printed;

FIG. 3 illustrates a printer having ink jet printing heads;

FIG. 4 illustrates a plan top view and an elevation cross-section elevation view of the transport mechanism of the printer illustrated in FIG. 3;

FIG. 5 illustrates: (a) an arrangement of ink jet print heads with respect to the sheet to be printed; (b) an arrangement where the area to be printed is oriented transverse to the direction of transport of the sheet; and, (c) an arrangement where the area to be printed is oriented longitudinal to the direction of transport of the sheet;

FIG. 6. illustrates details of the transport mechanism (a) for the arrangement of FIG. 5c and, (b) for the arrangement of FIG. 5a, respectively;

FIG. 7 is an elevation view of an aspect of the transport mechanism of FIG. 4 where the details of the baffles port connecting to the plenum are shown;

FIG. 8 illustrates an ink jet printer capable of printing both sides of a sheet; and

FIG. 9 illustrates another example of an ink jet printer capable of printing both sides of a sheet.

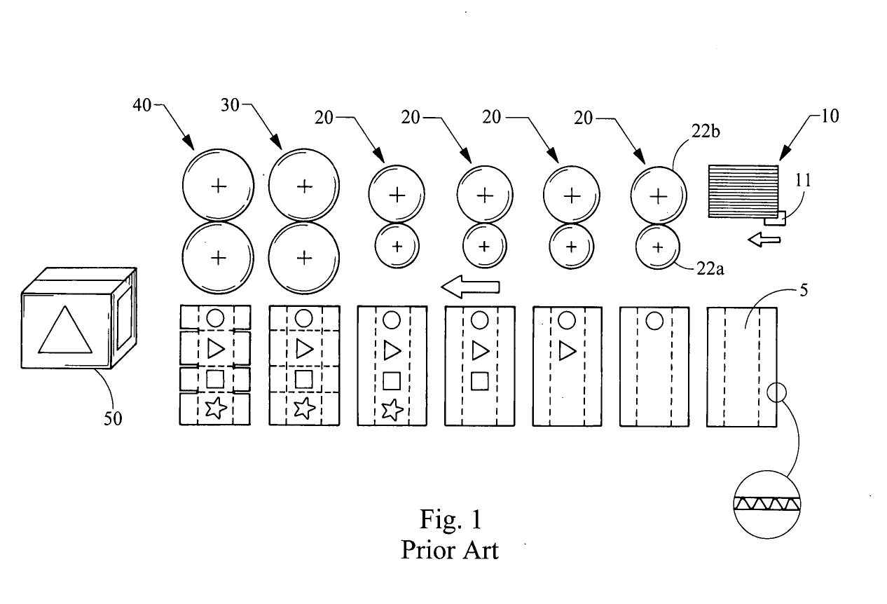

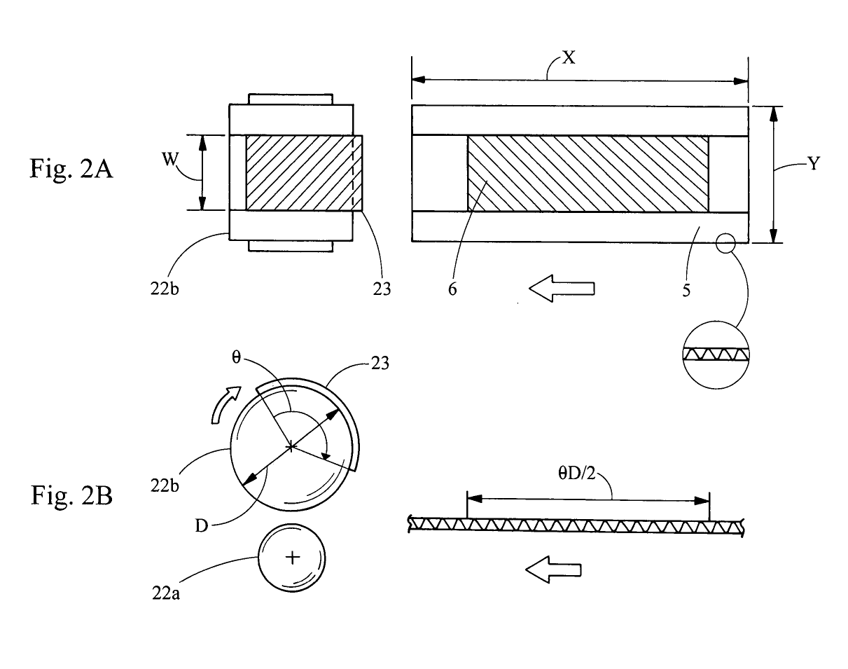

### BRIEF DESCRIPTION OF THE DRAWINGS

Exemplary embodiments may be better understood with reference to the drawings, but these embodiments are not intended to be of a limiting nature. Like numbered elements in the same or different drawings perform equivalent functions.

As used herein, a corrugated sheet is intended to mean any structure having at least a liner and a corrugated structure, the liner and the corrugated structure being integral or cojoined by a fixation means such as an adhesive an interlayer or the like. Such corrugated sheets are commonly made from cellulose-based materials, but as used herein the term is not intended to exclude other materials such as plastics, staple fibers, or other combinations of materials that may be formed into sheets. A corrugated structure has a minimum of a liner and a corrugated structure, but may include multiple layers of each type and with various means of joining the layers together.

A sheet may be a corrugated sheet, a flat sheet, a flat sheet with a corrugated sheet affixed to one surface, a corrugated sheet having flat sheets affixed to opposing surfaces thereof, on combinations of such arrangements. The corrugations may be sinusoidal, crenellated, triangular or the like. The sheet may be cellulose-based, plastic, fibrous or the like and may be a combination of a variety of materials such that a surface suitable for printing is formed.

An image may include a picture, a drawing, a geometric or abstract design, including text, and be of one or more colors. More than one image may be combined for printing on a surface or a face of the box or container.

In an ink-jet printing technology, a sheet 5 is printed in a non-contact manner such that an ink droplet is jetted out from an ink jet nozzle towards the surface of the sheet 5 to land at a certain position and thus forms a dot on the surface thereof. By controlling the formation of dots and the color of the dots, an image may be formed on the surface. As there is no contact between the print mechanism and the sheet 5 being printed, the deviation of the sheet 5 from alignment with respect to the direction of travel due to contact pressure differentials with a printing cylinder is avoided. Ink jet nozzles are arranged across the width of the sheet 5, corresponding to areas to be printed. Generally a plurality of nozzles are used and disposed so as to provide piecewise coverage of the printing area.

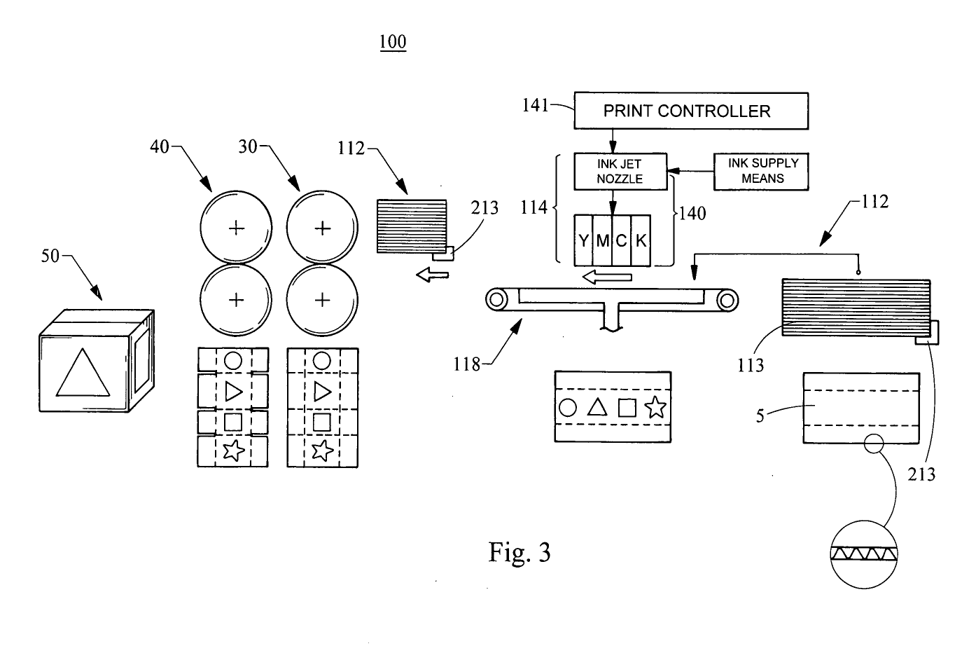

FIG. 3 is a simplified diagram of an ink-jet printing system 100, including a feeder 112 having a kicker 213 for feeding corrugated sheets 5 from a stack of sheets 113, one-by-one, a printing unit 114 for printing a surface of the sheet 5. The sheets output from the printing area may be stacked by a stacker (not shown) and then further processed using another feeder 1 12, having a kicker 213, and a scorer 30 and a slotter 40, so as to prepare the sheet 5 to be formed into a box 50. The sheets 5 may be stored after the creasing and slotting process and formed into boxes 50 later, and in a different location.

A transporting unit 118 receives the a sheet 5 from the feeder 112 and moves the sheet 5 at a uniform velocity v beneath the ink jet printing unit 114, which may have a plurality of nozzles (not shown) arranged so as to dispense ink of one or more colors. A print controller 141 accepts image data from a server, communications system or the like and converts the image data into a format compatible with the printer 100. This may include converting from a red (R), green (G), blue (B) color format typical of video displays to the YMCK format. The print controller may be a microprocessor, computer, state machine or similar device having appropriate electrical interface and associated memory, which may be volatile or non-volatile memory as is known in the art. Image data may be considered to represent any type of printed image, including text, graphics, photographs, computer generated art, or the like, and combinations thereof, which may be represented by a pattern of ink dots on a surface.

The print controller 141 and any other controller, server, user or client interface described herein, or the like, interprets instructions embodied in machine readable computer code as is known in the art. Instructions for implementing processes of print controller 141 or other computing device, the processes of a client application, the processes of a server, and/or the processes of a compiler program are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like. In an embodiment, the instructions may be stored on a removable media device for reading by local or remote systems. In other embodiments, the instructions may stored in a remote location for transfer through a computer network, a local or wide area network, a wireless network, or over telephone lines. In yet other embodiments, the instructions are stored within a given computer or system.

Furthermore, as is known in the art, actions performed by a computer may equally be performed by programmable logic, and by other means including analog circuitry and mechanical analogs of these devices.

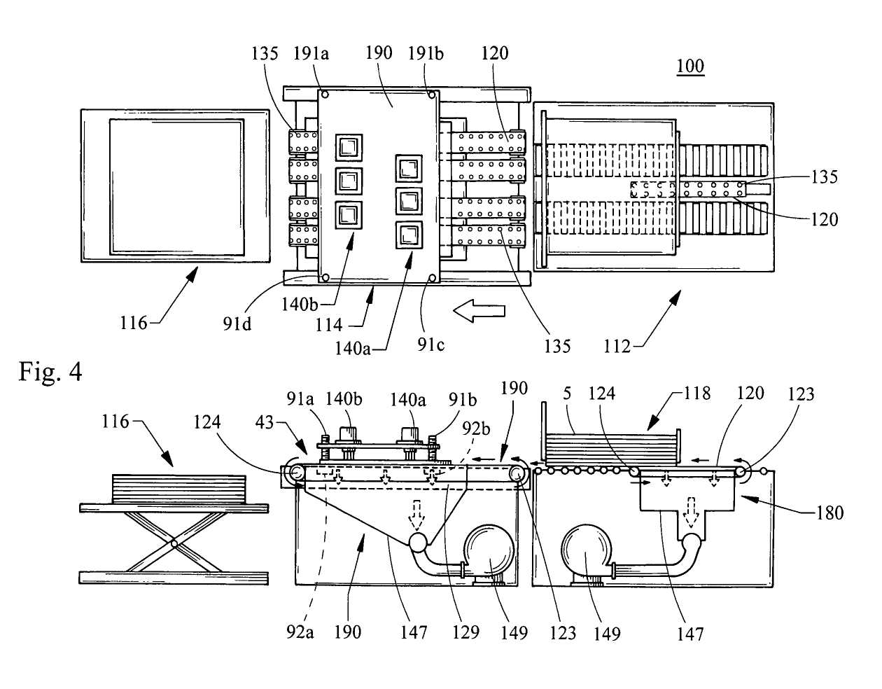

FIG. 4 is a more detailed example of an ink-jet printer 100. A feeder 112, a printing area 1 14, and a stacker 1 16 for stacking the printed sheets 5 are shown arranged in the direction of feeding of the sheets, The feeder 112 includes a hopper 118 in which the sheets 5 are received prior to feeding into the printing area; a first transport mechanism 180 that transports individual sheets 5 from the hopper 118 towards the printing area 114; and, a second transport mechanism 190 that transports the one-at-a-time fed sheet 5 beneath the print heads 140, located in the printing area 114.

Each of the transport mechanisms 180, 190 is similar in design and function, so that the discussion relating to transport mechanism 190 will suffice to explain the functioning of both transport mechanism 180 and 190 to a person of skill in the art. A conveyer belt 120 is disposed so that sheets 5 being fed from the hopper 118 are further transported through the printer area 114. The conveyer belt 120 may be a plurality of belts, as shown, disposed between rollers 123 and 124 so as to have an upper aspect facing the printing heads 140 and a lower aspect, displaced vertically from the upper aspect and traveling in an opposite direction thereto. Alternatively, a single belt may be provided, having a width substantially equal to that of the plurality of belts.

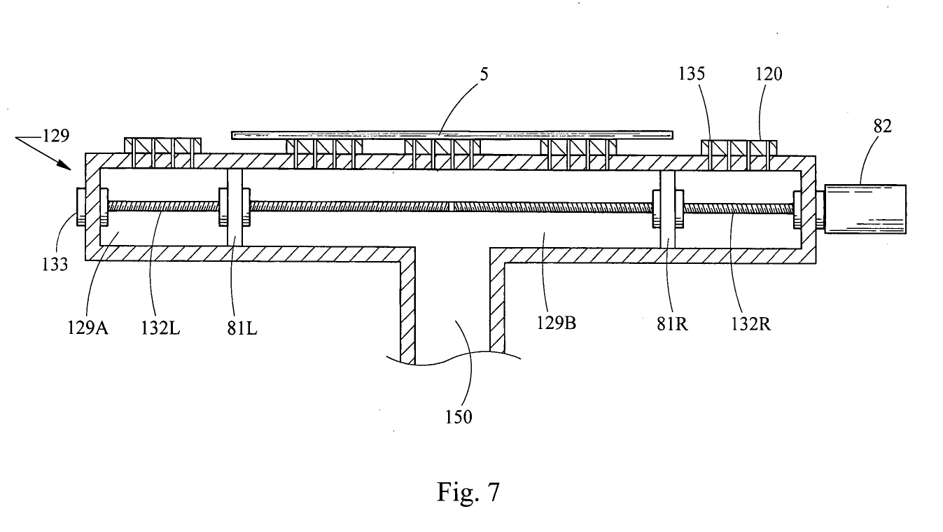

The belts are configured so as to be able to admit air through at least a porous portion of the transverse width thereof, such as by way of perforations or holes, 135 or pores. A plenum chamber 147 may be disposed below a portion of the upper aspect of the conveyer belt 120 so as to apply a suction force to the under side of the conveyer belt 120 through a suction chamber 129. A blower or fan 149 is connected to the plenum chamber 147 and operated so as to exhaust air from the plenum chamber 147. The suction chamber 129 is connected to the plenum chamber 147 by an aperture 150 (shown in FIG. 7) so that air admitted through the holes 135 and which may be admitted between the individual belts of the conveyer belt 120 is admitted into the plenum chamber 147, and subsequently exhausted by the blower 149. The flow of air is shown by the dashed-outline arrows.

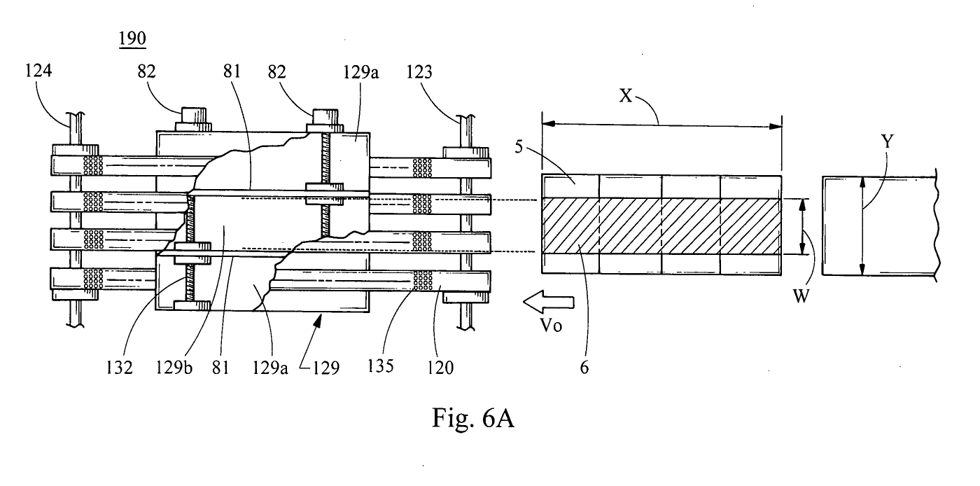

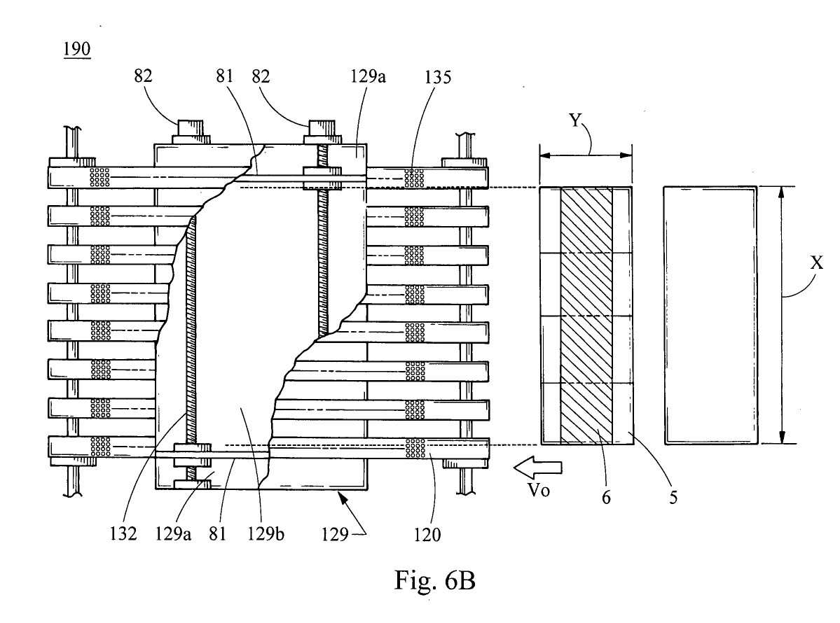

When a sheet 5 is disposed above the upper surface of the conveyer belt 120, the sheet 5 may cover the spaces between individual belts of the conveyer belt, and may cover a portion of a broad conveyer belt 120 to the extent of the dimensions of the sheet 5. As will be described, a pair of longitudinal baffles 81 and shown in FIG. 6 (sometimes called “dampers”) is disposed beneath the upper surface of the conveyer belt so as to limit the flow of air from areas of the conveyer belt not covered by the width of the sheet 5. The transverse distance between the baffles 81 is adjusted be less than the transverse width of the sheet 5, and may be set to a distance approximately corresponding to the transverse width of the printed area. When the communication between the suction device 127 and the plenum 147 is in a region near the centerline of the apparatus, the baffles 81 restrict the air flow such that air is preferentially drawn from the region between the baffles when compared to regions nearer either side of the apparatus. Thus the air pressure differential between the ambient environment at the top surface of the sheet 5, and the bottom surface of the sheet 5 positioned between the baffles 81, presses the sheet 5 against the conveyer belt 120. Also, in this manner, the amount of air drawn from outside of the region between the two baffles 81 may be minimized, so as to reduce the air flow in the vicinity of the printing heads 140. This may reduce disturbances to the ink jet drop trajectories.

At least one of rollers 123 and 124 is rotated by a motor so as to cause the linear motion of the conveyer belt 120 in the direction shown by the arrows. The motor may be a stepping motor, or other rotary device as is known in the art, or the rollers may be coupled to a prime mover such as an electric motor (not shown) by gears or belts, or the like. The lower surface of the sheet 5, being pressed down onto the upper surface of the conveyer belt 120, is transported through the printing region 114. The printing unit 114 may include sets of ink-jet heads 140a, 140b disposed so as to be oriented with the ink-jet nozzles thereof extending in a line perpendicular to the direction of travel of the sheet 5, and further disposed above the position of the sheet 5 as it passes the heads 140 along the direction of travel through the printer 100. A suction chamber 129 is disposed facing a side of the sheet 5 that does not face the ink-jet heads 140, with a conveyer belt 120 disposed between the suction device 129 and the sheet 5.

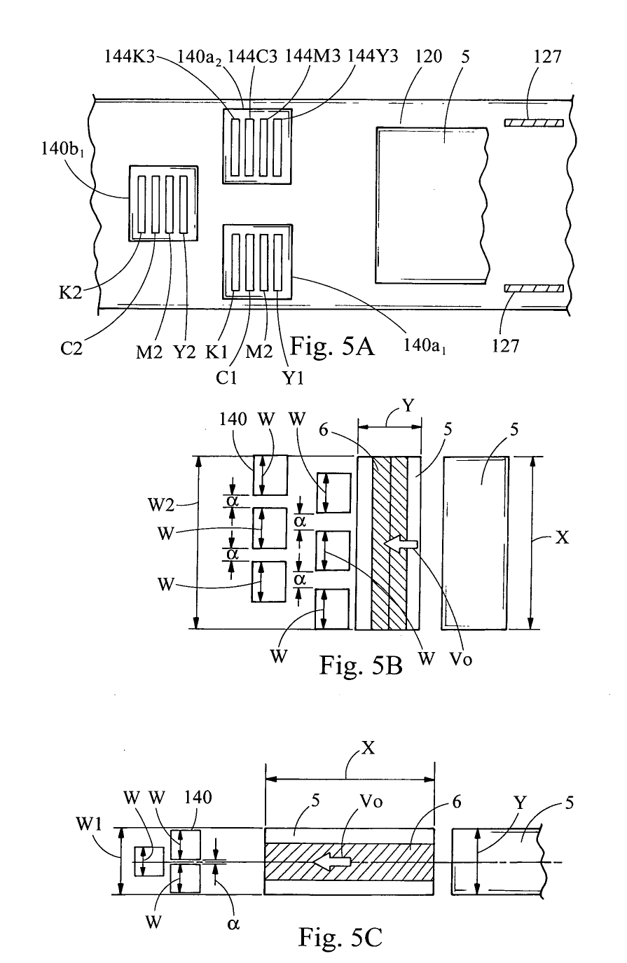

The printing unit 114 may have sets of ink jet heads 140 disposed above the sheet 5 and facing the surface of the sheet 5 that does not face either the conveyer belt 120 or the suction chamber 127. The ink jet heads 140 are directed such that ink is expelled downwardly so as to form dots with the desired density and color (dots per inch, DPI) on the surface of the sheet 5. As shown in FIG. 4, there are two sets of ink jet heads 140a and 140b, each set of heads having groups of nozzles 144Y, 144M, 144C and 144K (such as shown in FIG. 5a), corresponding to the yellow (Y), magenta (M), cyan (C) and black (K) ink. The nozzles 144 are disposed such that the ink-jet nozzles for each of the colors YMCK are parallel to each other, and the nozzles for each of the colors are separated by a distance along the direction of travel of the sheet 5. A controller 141 controls the action of the nozzles 144 so as to deposit the ink droplets in the proper locations to form the image desired.

The ink jet nozzles 144 are disposed a known distance from the opposing surface of the sheet 5, and the vertical position of the ink jet heads 140 may be adjusted to account for a thickness dimension of the sheet 5. Motorized jack screws 191a, b, c, and d, driven by motors 192a, b, c, and d, respectively, may be used to adjust the distance of the ink jet nozzles 144 from the top surface of the sheet 5 by raising and lowering the height of the platform 190, to which the ink jet heads 140 are mounted. In this manner, a desired distance between the ink jet nozzles 144 and the upper surface of the sheet 5 may be established, where different thicknesses of sheet 5 may be used from time-to-time.

FIGS. 5a-c illustrate several differing arrangements of the printing heads 140 and orientations of the sheet 5. FIG. 5a is a partial plan view of the printing area 114, showing only the print heads 140, a simplified representation of the conveyer belt 120, the sheet 5, and, optionally, sheet guides 127. In this aspect, the width of the sheet 5 to be printed corresponds to three separate ink jet print heads 140a1, and 140a2, disposed in a line transverse to the direction of motion of the sheet 5, and ink jet print head 140b1, which is located along the centerline of the feed path, and further from the feeder than the ink jet heads 140a1 and 140a2. As ink jet heads 140a1 and 140a2 are disposed with a gap between them in the transverse direction, ink jet head 140b1 is disposed so that a sheet traversing the printing area 114 may be printed upon by at least one of the print heads 140, resulting in a continuous image in the width region encompassed by the print heads 140. The print controller 141 manages the printing process so as to result in the proper density and spacing of ink dots to print the desired image. Each of the print heads 140 is includes a row of nozzles for each of the YMCK print colors to be used.

FIGS. 5b and 5c contrast the arrangement of print heads which may be used depending on the orientation of the sheet 5 in passing through the print area 114.

FIG. 5b shows an arrangement of the sheet 5 where the transverse direction of the sheet 5 is aligned with the longitudinal direction X of the sheet direction of feeding (shown by the arrowhead). Each of the print heads 140 has a width W, and a spacing α. Two groups of three print head 140 are disposed so that the total of six print heads spans the longitudinal dimension X of the sheet 5, or at least that portion of the longitudinal dimension on which printing is desired.

FIG. 5c illustrates an arrangement of print heads 140 corresponding to the situation where the sheet 5 is oriented such that the transverse direction Y is aligned with the direction of feeding (shown by the arrowhead). In this circumstance, the arrangement of three print heads 140, as shown also in FIG. 5a is sufficient to print the same or similar area 6 of the sheet 5.

In the printing area 114 of the printer 100, the sheet 5 may be held tightly to the conveyer belt 120 by the suction provided by the suction chamber 129 and the plenum 147 so that the distance between an upper surface of sheet 5 and the ink jet nozzles 144 remains substantially constant. Undesirable air flows associated with the suction process may be mitigated, and the overall air flow volume required may be reduced by the use of baffles 81 in the suction box 129. FIGS. 6a and b illustrate the suction box and baffles 81 for the arrangements shown in FIGS. 5b and c, respectively.

The sheet 5 may be oriented with either the longitudinal dimension (long) X or the transverse direction (width) Y in the direction of motion with respect to the printing heads 114. Where the orientation is such that the longitudinal dimension is in the direction of motion, the width of the printer 100, and distance between the baffles 81 of the suction box 129 are less than that where the transverse dimension Y of the sheet 5 is oriented in the direction of motion. In addition, the area of the gap transverse to the direction of motion that arises between successive sheets 5 being fed by the feeder 112 is also reduced when the longitudinal dimension of the sheet 5 is oriented in the direction of feeding. In such a circumstance, the amount of air flowing in the vicinity of the print heads 114 may be reduced and the print quality may be improved.

Depending on the width of the print area 6, one or more print head assemblies 114 may be used to provide coverage of the entire width of the print area. Economic considerations may lead to the use of multiple print heads aligned in a direction transverse to the direction of motion of the sheet 5. Where multiple print heads 114 are used, a gap may be provided between adjacent print heads 114 in the width direction. A second row of print heads 114 may be provided so that the gap is filled in when the printing process is performed. In such a situation, the operation of the print heads may be coordinated so that the image being formed has density of ink that is consistent with the situation where a single wide ink head is used.

FIG. 6a illustrates a plan view of the configuration of the transport mechanism 190 for a situation where the sheet 5 is oriented with the longitudinal direction in the direction of feeding. The width W of the printable area 6 is shown. Dotted lines extending from the end of the sheet 5 towards the transport mechanism 190 show the alignment of the area 6 intended for printing with the baffles 81. The top of the suction chamber 129 may be formed of a solid material, perforated by holes, be open, or be open in the regions underneath the individual belts of the conveyer belt 120. Air passing through the holes 135 or other porosity in the belts 120, when the holes or porosity is disposed over the suction chamber 129 is exhausted through the plenum 147 creating a downward force to hold the sheet 5 to the belt 120 as the sheet 5 passes through the printing area 114. Baffles 81 include at least two vertical plates extending from underneath the portion of the belt 120 contacting the sheet 5 to a location near a bottom surface of the suction chamber 129, serving to restrict the flow of air from the exterior environment through regions 129a, while providing access for air from the exterior environment to enter region 129b and thence to the plenum 147. A port (shown in FIG. 7) may be provided to effect air flow between the suction box 129 and the plenum 147, while providing clearance for the belts and other portions of the printer.

FIG. 6b illustrates a situation where the sheet 5 is disposed such that the transverse dimension Y thereof is oriented along the direction of feeding. The printing area 6 is of the same dimensions as in FIG. 6a. In this situation, as in the arrangement shown in FIG. 5b, the same printing area 6 corresponds to a larger dimensioning of the printer in the direction orthogonal to the direction of feeding when the direction of feeding of the sheet is in the transverse direction rather than the longitudinal direction. As in FIG. 6a, the maximum-width dimension of the printed area 6 is extended by dotted lines to show the correspondence with respect to the position of the baffles 81, where the baffles 81l and 81r are adjusted to provide a suction area under the entire printing area 6. In this example, the width of the printing area 6 is as wide as the maximum longitudinal dimension X of the sheet 5, rather than a portion of the transverse dimension Y. As such the amount of air which is accepted by the suction box 129 is greater. In addition, as the baffles 81 are moved nearer the edges of the sheet 5, air flow in this region may be greater than for the situation illustrated in FIG. 6a.

FIG. 7 shows baffles 81l and 81r threadedly engaged with screw shafts 132 extending transverse to the direction of sheet feeding. Each screw shaft 132 is has a left hand side 132l and a right hand side 132r, having opposite thread senses, but may be joined to form a single rotatable shaft supported by a bearing 133 at one end. The screw shaft 132 may be rotated by a motor 82, or manual means disposed at an opposite end of the shaft 132. Depending on the direction of rotation of the screw shaft 132, the transverse distance between the baffles 81l and 81r may be increased or decreased. As shown in FIG. 6a, the transverse spacing between the baffles 81 has been set such that each of the baffles 81 is collinear with the dotted line marking the outer extent of the printing area 6 in a transverse direction. Thus, when a sheet 5 is fed into the printing area, the suction force in area 129b is applied predominantly to the portion of the sheet 5 beneath the print heads 140 and corresponding to the area 6 on which a printing process is to be performed, holding that portion of the sheet tightly to the transport mechanism, and reducing the volume of air flow into the plenum 147. The dimensions of suction portion 129b may therefore be sized or adjusted to the width of the printed area 6.

Slots may be formed in the sheet 5 by a slotter 40 to permit the sheet 5 to be formed into a box 50. The slots may be formed either prior to of subsequent to feeding the sheets 5 through a printer 100, 200. Where the sheet 5 has been slotted prior to feeding through the printer, the sheet may be oriented so that, when the sheet 5 is fed in the direction of feeding, the slots are disposed further from the centerline of the printer so that the baffles 81 lie between the slots and the centerline of the printer. In this circumstance, the suction force in area 129b is applied to an unslotted surface of the sheet 5.

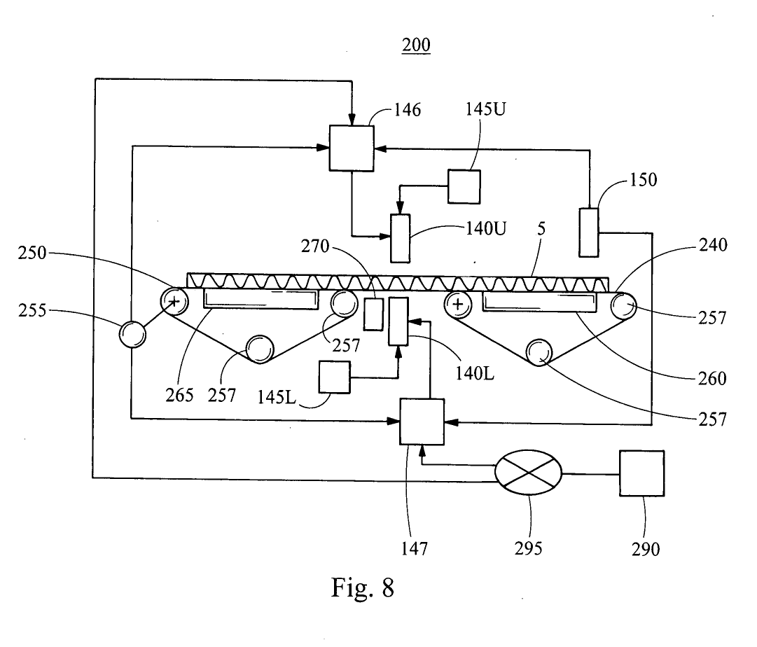

In another example shown in FIG. 8, an ink-jet printer 200 may be configured to print a sheet 5 on both sides thereof in a single pass of the sheet 5 thought the printer 200. Many of the aspects of the printer 200 are similar to those of the printer 100, and only the significant differences are described. Further, the aspects related to feeding from the input sheet supply, the stacking of the output and subsequent operations, are not shown. FIG. 8 has two sets of print heads 140 U and 140 L, disposed so as to face opposite surfaces of the sheet 5. A single sheet 5 is shown in a position such that it is disposed between the print heads 140 U and 140 L. A first conveyer belt 240 and a second conveyer belt 250 are driven by stepping motors (not shown) driven by pulse generators 255, and there may be one or more idler wheels 257. A first suction chamber 260 and a second suction chamber 265 are disposed beneath the upper surface of the conveyer belts 240 and 250 such that the sheet 5 is pressed against the upper surface of the conveyer belts 240, 250 by the differential in air pressure existing between the ambient environment and the air pressure inside of the suction chambers 260, 265. The motion of the conveyer belts 240, 250 is such that the sheet 5 moves from right to left through the printer 200 when the stepper motors are energized.

The upper and lower print heads 140 U and 140 L are supplied with ink from ink reservoirs 145 U and 145 L, and the printing action of the upper and lower print heads 140 U and 140 L regulated by a first print controller 146 and a second print controller 147, respectively. Either or both sides of the sheet 5 may be printed in one pass through the printer 200, in accordance with the desired images to be printed on the sheet 5. A sensor 150, which may be an optical sensor, or the like, determines the time when the leading edge of the sheet 5 is at a predetermined distance from the print heads 140 U and 140 L, and actuates the ink-jet nozzles 144 accordingly to produce the images desired. A tachometer or shaft encoder may be connected to one or more of the idler or driving rollers 256, 257 to measure the speed of the conveyer belts 240, 250. The print controllers 146, 147 may use the sensor output of the detection of the leading edge of the sheet and the speed of advance of the sheet 5 to determine the time to commence printing. It should be appreciated that the relative registration of the colors, in forming an image, is related predominantly to the accuracy of relative positioning of the print heads 140, and a constant transport velocity v. This same type of control mechanism can be applied to any of the printers in the examples herein. After printing, the sheets may be stacked prior to further such as scoring and slotting, or these operations may be performed in a continuous sequential process.

As the bottom side of the sheet 5 (that is, the side of the sheet 5 that has been printed by print head 140L) is forced against the second conveyer belt 250 by the action of the suction chamber 265, the printed image on the bottom side of the sheet 5 may be smudged or blurred if the ink is not sufficiently dry by the time the printed area contacts the second conveyer belt 250. A dryer 270 may be positioned between the lower print head 140 L and the second conveyer belt 250 to accelerate the drying of the ink. The dryer may be of any type such as using hot air, microwave energy, infra-red or ultraviolet radiation or the like, so long as the sheet can be effectively dried so as to avoid smudging. In addition, print head 140L may be located closer to the end of the first conveyer belt 240 than to the second conveyer belt 250 so as to increase the ink drying time. The vertical position of the upper print head 140 U may be adjusted to achieve an optimal printing distance with respect to the facing surface of sheet 5, taking account of the thickness of sheet 5. The distance between the lower print head 140 L and the lower facing surface of the sheet 5 may not be adjusted, as the distance does not change with sheet thickness.

Thus, printer 200 may apply printing to both surfaces of a sheet 5 in a single operation, where differing images may be produced in accordance with the data and instructions furnished to the print controllers 146 and 147. The print controllers 146, 147 may receive data for controlling the printer and the images to be printed from a server 290 or other computer, and the server 290 or other computer may be either local or remotely located. In an aspect, the connection between the server 290 and the print controllers 146 and 147 may be over a local area network, a wide area network 290 such as the Internet, or by wireless communication techniques.

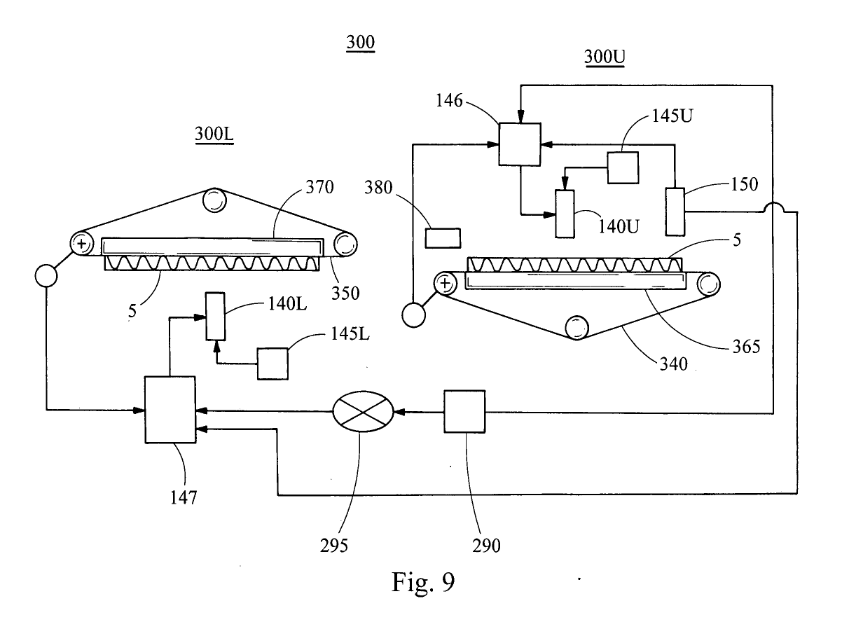

In still another example of a printer 300, shown in FIG. 9, two sequentially disposed printer units 300U and 300L may be used to print two surfaces of the sheet 5 in one operation. As in the previous examples, only one side may be printed if the print instructions do not require printing on both sides of the sheet 5. Only significant differences between the printer 300 and the previous examples are described. The printer 300 includes an upper surface printer 300 U and a lower surface printer 300L. The feeder, the stacker 116, slitter 30 and slotter 40 are not shown, but these aspects are discussed in previous examples. The printer 300 U is substantially the same as printer 100 and serves to print on an upper surface of sheet 5. In addition, a dryer 380 is disposed between the print head 140 U on the printer 300 U and the beginning of the second conveyer belt 350 of the printer 300 L. The dryer 380 is disposed such that the ink that was used to print the image on the upper surface of the sheet 5 is sufficiently dry that it is not smudged or blurred by contact with the second conveyer belt 350, where the sheet is held to the conveyer belt 350 by the differential in air pressure between the ambient environment and the suction box 370 associated with the second printer 300L. Print heads 140 L, are disposed below the sheet 5 in the second printer so that the side that was not printed in the first printer 300 U is now printed in the second printer 300L. The order of printers 300U and 300L is not significant, however the first printed side should be sufficiently dry when it contacts the conveyer belt of the second printer so that blurring is not experienced.

In each of the printers 300 U and 300L, the sheet 5 is disposed between the print head 140 and a surface of the conveyer belt 340, 350. Consequently, each of the print heads may be capable of adjustment in the vertical direction so as to accommodate sheets 5 of varying thickness, from print-job-to-print-job. The distance adjustment may be performed manually, or by a mechanism under the control of the print controllers.

Although only a few exemplary embodiments have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A printer, comprising:
a conveyer belt having a plurality of apertures extending between a first side and a second side thereof;
a suction unit for sucking a corrugated sheet to be printed toward the first side of the conveyor belt;
a plurality of ink jet nozzles disposed transverse to the direction of motion of the conveyer belt, the ink jet nozzles spaced apart from the surface of the corrugated sheet to be printed;
wherein the conveyer belt is an endless belt, engaged with pulleys separated from each other along the direction of motion, and the suction unit includes a suction box communicating with the apertures of the conveyer belt through a plurality of perforated holes.

2. The printer of claim 1, wherein the suction box has and a pair of baffle plates adjustable such that the width of the suction area corresponds approximately to the width of a printing area.

3. A printer, comprising:
means for feeding a sheet to be printed; and
a plurality of ink jet nozzles disposed transverse to the direction in which the sheets are fed and spaced apart from the surface of the sheets to be printed at a predetermined distance, wherein dots are formed on the surface of the sheet by ink droplets jetted out from the plurality of ink jet nozzles toward the surface of the sheet,
wherein the means for feeding includes a pair of pulleys separated from each other in the feeding direction, and an endless conveyor belt including a plurality of perforated holes on the surface thereof, the endless belt movable by the pair of pulleys; a suction unit for sucking the sheet toward the surface of the conveyor belt through the plurality of perforated holes, the suction unit including a suction box vented through the plurality of perforated holes, a means for sucking air from the suction box, and a pair of baffle plates in the suction box for adjusting a suction area in the suction box in accordance with a width of a printing area on the sheet, the width being substantially perpendicular to the feeding direction.

4. The printer of claim 3, wherein the corrugated sheet is a cardboard sheet suitable for forming into a box or container.

5. A printer, comprising,
a conveyer belt having a porosity to air;
a suction box, disposed opposite a first surface of the conveyer belt; and
a ink jet print head disposed facing a second surface of the conveyer belt,
wherein the suction box has a pair of baffles spacable apart so that a suction area is formed beneath approximately the width of a print area.

6. The printer of claim 5, wherein the porosity comprises a pattern of apertures extending between opposing surfaces of the conveyer belt.

7. The printer of claim 6, wherein the conveyer belt is a plurality of belts disposed so as to be separated by a distance orthogonal to the direction of motion thereof, and moved by a common roller.

8. The printer of claim 5, having ink jet nozzles oriented linearly, and disposed orthogonal to a direction of travel of the conveyer belt, and the ink jet nozzles configured to eject ink perpendicular to the second surface of the conveyer belt.

9. The printer of claim 5, wherein the distance between the print head and the print head and the second surface of the conveyer belt is adjustable.

10. The printer of claim 5, further comprising a print controller, configured to accept image data and operate the print head to form an image in accordance with the image data.

11. The printer of claim 10, wherein the image data is received from a server on a network.

12. The printer of claim 11, wherein the image data is encoded on a carrier wave.

13. The printer of claim 10, wherein image data in red, green, blue (RGB) format is converted to YMCK format by the print controller.

14. The printer of claim 5, wherein the suction box is sized to accommodate a corrugated sheet where a first dimension of the sheet in the direction of travel of the conveyer belt is greater than a second dimension of the sheet in the direction transverse to the direction of travel of the conveyer belt.

15. The printer of claim 5, wherein an optical sensor detects a first edge of a sheet being carried by the conveyer belt and the print controller is configured to accept the detection signal from the optical sensor and speed information from the conveyer belt, and to control the print head to print the image at a desired location with respect to the first edge.

16. The printer of claim 5, wherein a corrugated sheet is oriented such that the corrugations are orthogonal to the direction of travel through the printer.

17. The printer of claim 5, further including a dryer.

18. A method of printing on a surface of an individual sheet, the method comprising:
providing a conveyer belt with a suction box disposed facing a first surface thereof;
providing an ink jet print head disposed such that the ink jet nozzles are in a line perpendicular to the direction of motion of the conveyer belt;
disposing the ink jet print head facing a second surface of the conveyer belt;
sensing the position of a first edge of the sheet; and
controlling the ink jet print head to deposit ink to form an image in accordance with image data received by a controller.

19. The method of claim 18, further comprising:
adjusting baffles provided in the suction box so that a suction area between the baffles is formed approximately below the area on which an image is printed.

20. The method of claim 19, wherein the sheet is a corrugated cardboard sheet for forming into a box, the sheet being slotted from sides opposed to each other; a printing area formed on a non-slotted portion of the sheet corresponding to a side face of the box, and the pair of baffles adjusted so that the slots are disposed outside of the suction area formed between the baffles.

21. The method of claim 18, wherein the orientation of the sheet with respect to the direction of motion is selected in accordance with one of the size and the position of the printing image, or a direction in which the sheet has been slotted.

22. The method of claim 18, wherein a set of ink jet nozzles of the ink jet head are selected in accordance with one of the size and the position of the printing image, or a direction in which the sheet has been slotted.

23. The method of claim 18, wherein the image data is received in RGB format and converted to YCMK format for controlling the ink jet print head.

24. The method of claim 18, further comprising adjusting the distance between the print head and the second surface to compensate for a thickness of the sheet.

25. The method of claim 18, further comprising positioning the sheet such that the maximum dimension of the sheet is in the direction of travel of conveyer belt.

26. A printer, comprising:
means for transporting individual sheets;
means for printing images on individual sheets; and
means for holding the individual sheets against the means for transporting.

27. A printer, comprising:
a first printing mechanism, and a second printing mechanism, the first and second printing mechanism sequentially disposed along a path of a sheet to be printed;
each of the first and the second printing mechanism comprising
a conveyer belt having a porosity to air;
a suction box, disposed opposite a first surface of the conveyer belt; and
a print head disposed facing a second surface of the conveyer belt,
wherein the print head of the first printing mechanism is disposed opposite a first side of the sheet to be printed, and the print head of the second printing mechanism is disposed opposite a second side of the sheet to be printed.

28. The printer of claim 27, wherein a dryer is disposed between the print head of the first printing mechanism and the second printing mechanism.

29. The printer of claim 27, further comprising a print controller, configured to accept image data and operate the print head to for an image in accordance with the image data.

30. The printer of claim 29, wherein each of the first printing mechanism and the second printing mechanism has an associated print controller coupled to the respective print head.

31. A printer, comprising:
a first conveyer belt and a second conveyer belt, sequentially disposed along a path of a sheet to be printed;
a first suction box and a second suction box, disposed opposite a first surface of the first conveyer belt and a first surface of the second conveyer belt, respectively;
an upper print head disposed so as to eject ink in a downward direction towards an upper surface of the sheet to be printed; and
a lower print head disposed so as to eject ink in an upward direction towards a lower surface of the sheet to be printed.

32. The printer of claim 31, wherein a dryer is disposed between one of the upper print head or the lower print head and the second conveyer belt.

33. A printer, comprising:
means for conveying a sheet to be printed; and
a plurality of ink jet nozzles disposed transverse to a direction of motion of the sheet, and spaced apart from a surface of the sheet to be printed,
wherein a first plurality of ink jet nozzles is disposed opposing a second plurality of ink jet nozzles such that the sheet to be printed is conveyed therebetween by the means for conveying.

34. The printer of claim 33, wherein the distance between the ink jet nozzles and the surface to be printed is adjustable.

35. The printer of claim 33, wherein ink is jetted from the ink jet nozzles towards the surface of the sheet to be printed.

36. The printer of claim 33, wherein an upper surface of the sheet and a lower surface of the sheet are printed by a single pass through the printer.

37. The printer of claim 33 where the conveying means further comprises a first means and a second conveying means spaced apart from each other at a predetermined distance in the of direction of motion such that the ink jet nozzles are disposed therebetween.

38. The printer of claim 37, wherein the first plurality of ink jet nozzles are disposed to be opposed to an upper surface of the sheet, the second plurality of ink jet nozzles are disposed to be opposed to a lower surface of the sheet, and further disposed between said first and second conveyors.

39. The printer of claim 37, wherein the first conveying means and the second conveying means each have a conveyer belt and a lower surface of the sheet contacts the conveyer belt of the first conveying means and an upper surface of the sheet contacts the conveyer belt of the second conveying means.

40. The printer of claim 33 wherein the means for conveying further comprises a means for applying a differential air pressure between a first side of the sheet and the second side of the sheet.

41. The printer of claim 33, wherein the plurality of ink jet nozzles are disposed in groups, each group having a dimension in the direction transverse to the direction of motion of the sheet which is less than the width of the printing area.

42. The printer of claim 33, wherein a plurality of groups of printing nozzles is disposed in a direction transverse to the direction of motion of the sheet, and a gap is provided therebetween in the transverse direction, and at least one group of printing nozzles is disposed upstream of the plurality of groups of printing nozzles such that the at least one group of printing nozzles overlaps the gap.

43. The printer of claim 33, wherein the sheet is an individual corrugated cardboard sheet and the means for conveying includes a pair of pulleys separated from each other in the feeding direction engaging an endless belt disposed therebetween, the endless belt having a plurality of apertures between a top side and a bottom side of a belt surface.

44. The printer of claim 43, further including a suction unit for sucking the corrugated cardboard sheet toward an opposing surface of said conveyor belt.

45. The printer of claim 33, further including a dryer.

46. The printer of claim 37, further including a dryer disposed between the second printing nozzle and the second means for conveying.
